(19) United States
(12) Patent Application Publication
(10) Pub. No.: US 2013/0011717 A1
(43) Pub. Date: Jan. 10, 2013

(54) BATTERY AND ULTRASONIC WELDING SYSTEM USED IN PRODUCING THEREOF

(75) Inventor: Hiroaki Yotsumoto, Tokyo (JP)

(73) Assignee: MITSUBISHI HEAVY INDUSTRIES, LTD., Tokyo (JP)

(21) Appl. No.: 13/636,476

(22) PCT Filed: Mar. 22, 2011
(86) PCT No.: PCT/JP2011/056764

§ 371 Date: Sep. 21, 2012

(30) Foreign Application Priority Data
Mar. 26, 2010 (JP) 2010-072200

(51) Int. Cl. H01M 2/22; B23K 20/10; B23K 31/12; H01M 10/02

(52) U.S. Cl. 429/153; 228/1.1

(57) ABSTRACT

In welding between a tab bundle and lead, the outer edge of a lead on the electrode side cannot be connected to the tab bundle, even though the tab bundle extended from the electrode stacked body and a part of an end portion of the lead are connected. This leads to the outer edge bended up, damaging the tab and causing contact failure between the electrode plate and the electrode terminal. With the battery of the present invention, such contact failure can be prevented. It includes an electrode stacked body (10) and a lead (17) having the first end which is connected to a tab bundle (15), wherein a first end of the lead (17) is connected to the tab bundle (15) by ultrasonic welding so as to include at least an outer edge (17a) of the lead (17).

### TECHNICAL FIELD

The present invention relates to a battery having an electrode stacked body in which a plurality of electrode plates are stacked (for example, a stack-type secondary battery) and an ultrasonic welding system used in producing of the battery.

Priority is claimed on Japanese Patent Application No. 2010-072200 filed on Mar. 26, 2010, the content of which is incorporated herein by reference.

### BACKGROUND ART

A stack-type secondary battery, a typical example of which is a lithium-ion secondary battery, is provided with an electrode stacked body in which a plurality of positive electrode plates and a plurality of negative electrode plates are alternately stacked through a separator.

In the electrode stacked body of the stack-type secondary battery, each of the plurality of positive electrode plates and each of the plurality of negative electrode plates are individually provided with a tab, and tabs of the positive electrode plates and those of the negative electrode plates are respectively put together to give tab bundles. Then, an end of each tab bundle is connected to an end of a lead, and the other end of the lead is connected to a positive electrode terminal or a negative electrode terminal.

In production of the above-described secondary battery, it is necessary to connect the tab bundle to the lead. A conventional method for connecting a tab bundle to a lead includes a method disclosed in Patent Literature 1 shown below.

### RELATED ART LITERATURE

### Patent Literature

Patent Literature 1: Japanese Patent Application Laid-Open No. 2003-223880

### DISCLOSURE OF INVENTION

### Problems to be Solved

According to the connecting method disclosed in Patent Literature 1, a tab bundle is caused to overlap with an end portion of a lead, and ultrasonic waves are applied to a portion where they overlap with each other, by which they are connected by ultrasonic welding.

In the method disclosed in Patent Literature 1, as shown in FIG. 7 attached to the present specification, the tab bundle 1 is connected to the portion 2b at an end of the lead 2. However, for example, in a case where a movement accuracy of the ultrasonic welding device is not high, the tab bundle 1 is connected to the lead 2, with an outer edge 2a of the lead 2 on the side of electrode plates not being connected. In this instance, since the outer edge 2a of the lead 2 on the side of electrode plates is not connected, the outer edge 2a is bended up on the side of the tab bundle 1.

Here, an electrode stacked body in which the lead is connected to the tab bundle is contained in a battery case, with the tab bundle 1 and the lead 2 folded back. Then, as shown in FIG. 8, in the course of folding back the lead 2, or the like, the outer edge 2a can damage the base portion 1a of the tab bundle 1 to cause a connection failure between the electrode plate and the electrode terminal.

With attention given to the above-described problem of the conventional technology, the present invention provides a battery capable of avoiding a connection failure between the electrode plate and the electrode terminal. The present invention also provides an ultrasonic welding system used in producing of the battery.

### Means for Solving the Problems

In order to solve the above-described problem, the battery of the present invention is a battery including: an electrode stacked body, in which a plurality of electrode plates are stacked; and a lead having the first end which is connected to a tab bundle formed by putting together tabs extending individually from the plurality of electrode plates, wherein the first end of the lead is connected to the tab bundle by ultrasonic welding so as to include at least an outer edge of the lead.

Further, in order to solve the above-described problem, the ultrasonic welding system of the present invention is an ultrasonic welding system which connects a lead to a tab bundle in a battery having an electrode stacked body, in which a plurality of electrode plates are stacked, and having the tab bundle formed by putting together tabs extending individually from the plurality of electrode plates, the ultrasonic welding system including: an ultrasonic welder having a horn which applies ultrasonic waves to a welded spot between the tab bundle and the lead to weld the welded spot; a moving device which changes a relative position between the tab bundle, the lead and the horn; an imaging device which takes photographs of a zone to which the horn applies the ultrasonic waves; a control device which controls at least two of the tab bundle, the lead and the horn to move relatively by the moving device in such a manner that the tab bundle, an outer edge of the lead and an ultrasonic wave applying surface of the horn are arrayed in a direction in which the horn moves in the zone where the imaging device takes photographs; and a second control device which controls the ultrasonic wave applying surface of the horn to move toward a zone including the outer edge of the lead, thereby connecting the zone including at least the outer edge of the lead to the tab bundle by the ultrasonic welder.

In the present invention, since a portion including the outer edge of the lead is melted and connected to the tab bundle, the outer edge of the lead is made smooth with respect to the tab bundle. Therefore, the outer edge of the lead is not bended up to damage a base portion of the tab bundle, making it possible to avoid the contact failure between the electrode plate and the electrode terminal.

### Advantageous Effects of Invention

In the present invention, the portion including the outer edge of the lead is melted and connected to the tab bundle. Thus, the outer edge of the lead is not bended up to the tab bundle. Therefore, according to the present invention, where the lead is folded back for being contained in a battery case, the outer edge of the lead does not damage the base portion of the tab bundle, making it possible to avoid a connection failure between an electrode plate and an electrode terminal.

### BRIEF DESCRIPTION OF THE DRAWINGS

FIG. 1 is a cutaway perspective view which shows major parts of a secondary battery related to an embodiment of the present invention.

FIG. 2 is a block diagram which shows an ultrasonic welding system related to an embodiment of the present invention.

FIG. 3 is a block diagram which shows major parts of an ultrasonic welding device in operation in an embodiment of the present invention.

FIG. 4A is a drawing which shows a tab bundle and a lead related to an embodiment of the present invention. This is a plan view of the tab bundle and the lead.

FIG. 4B is a drawing which shows the tab bundle and the lead related to an embodiment of the present invention. This is a side view of the tab bundle and the lead.

FIG. 5A is a drawing which shows a tab bundle and a lead of a modified example related to an embodiment of the present invention. This is a plan view of the tab bundle and the lead.

FIG. 5B is a drawing which shows the tab bundle and the lead of the modified example of an embodiment of the present invention. This is a side view of the tab bundle and the lead.

FIG. 6 is a block diagram which shows an ultrasonic welding device of the modified example related to an embodiment of the present invention.

FIG. 7 is a drawing showing a portion at which a tab bundle is conventionally connected to a lead.

FIG. 8 is a drawing showing the portion at which the tab bundle is conventionally connected to the lead in the course of folding back the lead.

### BEST MODE FOR CARRYING OUT THE INVENTION

Hereinafter, a description will be given of an embodiment of the battery of the present invention and also an embodiment of the ultrasonic welding system used in producing of the battery.

The battery of the present embodiment is a stack-type secondary battery, an example of which is a lithium-ion secondary battery. The present invention is applicable not only to a lithium-ion secondary battery but also applicable to a battery in which a tab bundle of a plurality of electrodes constituting the battery is required to be connected to a lead.

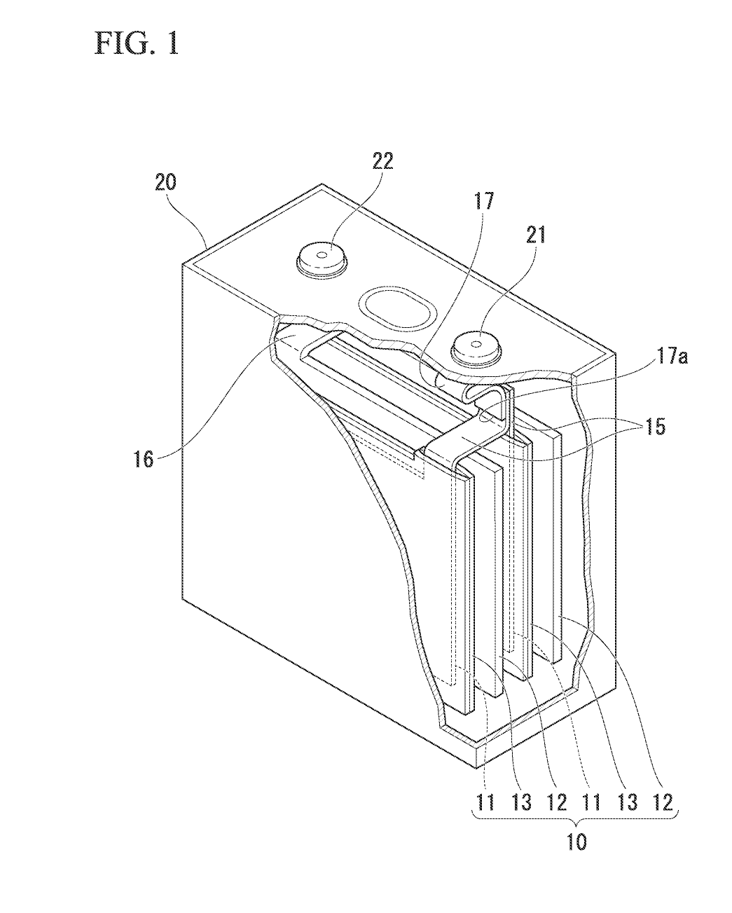

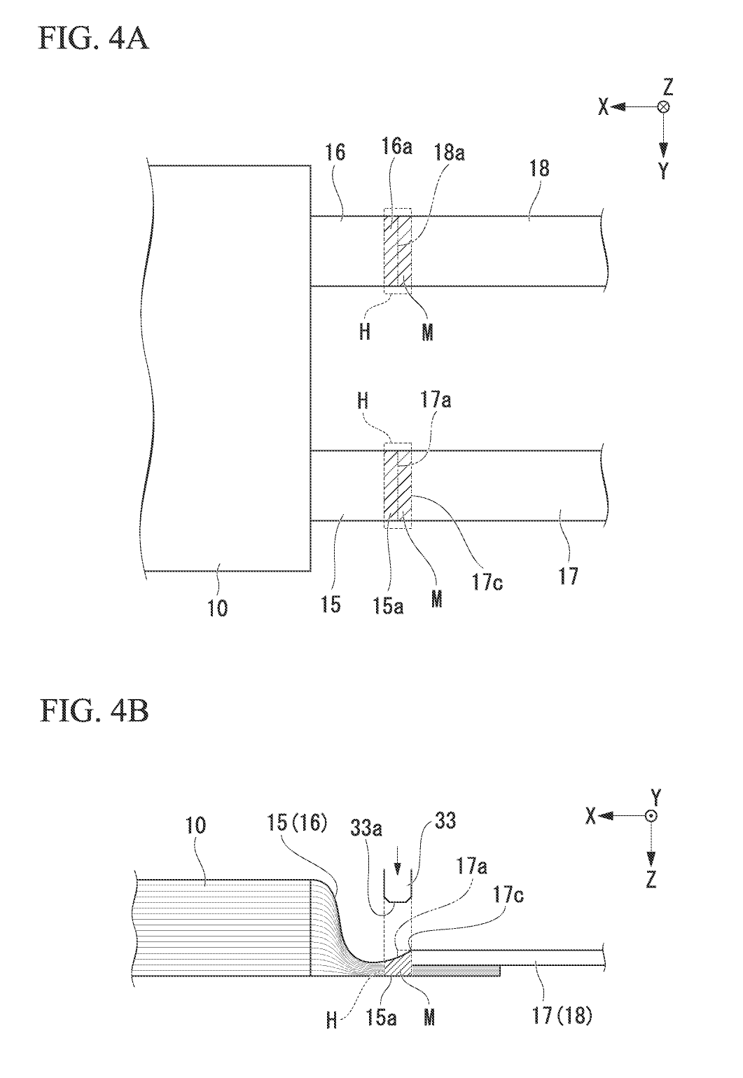

As shown in FIG. 1, the secondary battery is provided with a plurality of positive electrode plates 11, a plurality of negative electrode plates 12, an insulating separator 13 arranged between a positive electrode plate 11 and a negative electrode plate 12, a cell case (battery case) 20 which contains them, a positive electrode terminal 21 and a negative electrode terminal 22 which are fixed through a resin, or the like, within one plane of the cell case 20, a positive electrode lead 17 which connects a positive-electrode tab bundle 15, that is, a bundle of tabs extending from the positive electrode plate 11, with the positive electrode terminal 21, and a negative electrode lead 18 (shown in FIG. 4A) which connects a negative-electrode tab bundle 16, that is, a bundle of tabs extending from the negative electrode plates 12, with the negative electrode terminal 22. The positive electrode plate 11 is one in which an active material for a positive electrode is coated on a current collecting body (for example, aluminum), while the negative electrode plate 12 is also one in which an active material for a negative electrode is coated on a current collecting body (for example, copper). Tabs extending from the positive electrode plate 11 and the negative electrode plate 12 are made with the same material as a current collecting body and formed at the same time, for example, when a current collecting body is formed by punching a base material.

In the following description, the positive-electrode tab bundle 15 and the negative-electrode tab bundle 16 are sometimes collectively referred to as a “tab bundle,” and the positive electrode lead 17 and the negative electrode lead 18 are also collectively referred to as a “lead.”

Each of the plurality of positive electrode plates 11 is covered with the insulating separator 13 made with polypropylene, polyethylene or the like. In the present embodiment, as shown in FIG. 1, the positive electrode plate 11 is packed with the separator 13. Alternatively, the negative electrode plate 12 may be packed with the separator 13. The plurality of positive electrode plates 11 covered with the separators 13 and the plurality of negative electrode plates 12 are stacked alternately to constitute a stacked body 10. When the stacked body is contained in the cell case 20, the stacked body 10 is set as one block and, for example, three blocks are contained in the cell case 20. The stacked body 10 which constitutes one block is firmly joined with an insulation tape or the like (not illustrated) and prevented from being deviated on stacking electrode plates. Further, a protection plate (not illustrated) made with a plastic material or the like is used to protect the vicinity of the stacked body 10.

As described above, in producing the secondary battery, the tab bundles 15, 16 are required to be connected to the leads 17, 18 and they are connected by an ultrasonic welding system. Thus, in the present embodiment, a description will be hereinafter given of a constitution of the ultrasonic welding system. The following description will mainly deal with a case where the tab bundle 15 of the plurality of positive electrode plates 11 is connected to the positive electrode lead 17 by ultrasonic welding. This is, however, also similar to a case where the tab bundle 16 of the plurality of negative electrode plates 12 is connected to the negative electrode lead 18 by ultrasonic welding.

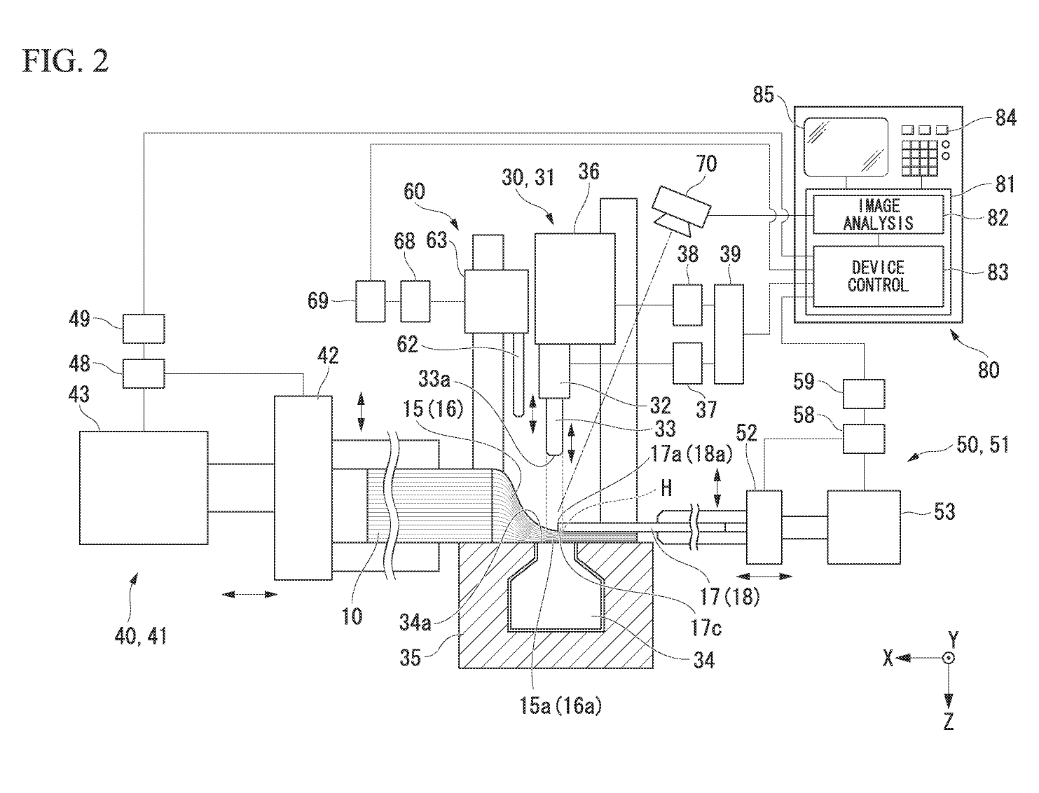

As shown in FIG. 2, the ultrasonic welding system includes an ultrasonic welding device 30, a stack-body moving device 40 which holds and moves the stacked body 10, a lead moving device 50 which holds and moves the lead 17, a tab pressing device 60 which presses the positive-electrode tab bundle 15 extending from the stacked body 10, a camera 70 which takes photographs of a zone including a portion to which the ultrasonic welding device 30 applies ultrasonic waves, and an integrated controller 80 which controls these devices.

The ultrasonic welding device 30 includes an ultrasonic welder 31 and a control circuit 39 which controls the ultrasonic welder 31.

The ultrasonic welder 31, which is arranged between a lead moving device 51 and a stack-body moving device 41 in an X direction, includes an transducer 32, a horn 33 which vibrates by vibration of the transducer 32 to apply ultrasonic waves to a welded spot between the positive-electrode tab bundle 15 and the positive electrode lead 17, an anvil 34 which receives the ultrasonic waves from the horn 33 via the welded spot, a table 35 which supports the anvil 34 and others, a compression mechanism 36 which presses the horn 33 to the welded spot, a transducer driving circuit 37 which has an oscillator for vibrating the transducer 32, and a compression driving circuit 38 which drives the compression mechanism 36. In the following description, a direction in which the horn 33 is pressed to the welded spot by using the compression mechanism 36 is referred to as the +Z direction, one direction which is perpendicular to the Z direction is referred to as the X direction, a direction which is perpendicular to the Z direction and the X direction is referred to as the Y direction. Further, in FIG. 2, regarding the X direction, a direction which moves from the lead moving device 50 to the stack-body moving device 40 is referred to as the +X direction. Regarding the Y direction, an upper side on the paper surface is referred to as the +Y direction.

On the horn 33, there is formed an ultrasonic wave applying surface 33a which is in contact with the welded spot and applies ultrasonic waves to the welded spot. Further, on the anvil 34, there is formed an ultrasonic wave receiving surface 34a which is in contact with the welded spot and receives the ultrasonic waves from the horn 33 via the welded spot.

The stack-body moving device 40 includes a stack-body moving device 41 which controls the positive-electrode tab bundle 15 extending from the stacked body 10 to move into a space between the horn 33 of the ultrasonic welding device 30 and the anvil 34 thereof, and a control circuit 49 which controls the stack-body moving device 41. The stack-body moving device 41 includes a holding mechanism 42 which holds the stacked body 10, a movement mechanism 43 which controls the holding mechanism 42 to move in the X and the Y directions, and a driving circuit 48 which drives the holding mechanism 42 and the movement mechanism 43.

The lead moving device 50 includes a lead moving device 51 which controls an end portion 17c of the positive electrode lead 17 to move into a space between the horn 33 of the ultrasonic welding device 30 and the anvil 34 thereof, and a control circuit 59 which controls the lead moving device 51. The lead moving device 51 includes a holding mechanism 52 which holds the positive electrode lead 17, a movement mechanism 53 which controls the holding mechanism 52 to move in the X and the Y directions, and a driving circuit 58 which drives the holding mechanism 52 and the movement mechanism 53.

The tab pressing device 60 includes a pressing member 62 which is in contact with the positive-electrode tab bundle 15, a movement mechanism 63 which controls the pressing member 62 to move in the Z direction, a driving circuit 68 which drives the movement mechanism 63, and a control circuit 69 which controls the tab pressing device 60.

The camera 70 is fixed for its direction in such a manner that it is able to take photographs of a zone, which is positioned on the ultrasonic wave receiving surface 34a of the anvil 34, including an ultrasonic wave applying zone H which is opposite the ultrasonic wave applying surface 33a of the horn 33.

The integrated controller 80 includes a control unit 81, an input unit 84 which gives instructions, or the like, to the control unit 81, and an output unit 85 which outputs processing contents, or the like, at the control unit 81. The control unit 81 is provided with an image analysis unit 82 which analyzes an image photographed by the camera 70 and a device control unit 83 which controls various devices 30 to 60.

In the above-described ultrasonic welding system, a first moving device, which changes a relative position in the X direction between the positive electrode lead 17 and the horn 33 of the ultrasonic welder 31, is constituted so as to have a lead moving device 51. A second moving device, which changes a relative position in the X direction between the positive-electrode tab bundle 15 extending from the stacked body 10 and the positive electrode lead 17, is constituted so as to have a stack-body moving device 41 and a lead moving device 51. In the present description, a constitution which has the first moving device and the second moving device is referred to as a “moving device.” Further, the first control device, which changes a relative position between the positive electrode lead 17 and the horn 33 by using the first moving device based on an image of the imaging device (camera 70), is constituted so as to have the integrated controller 80 and the control circuit 59 of the lead moving device 50. Still further, the second control device, which connects the positive-electrode tab bundle 15 to the positive electrode lead 17 by using the ultrasonic welder 31, is constituted so as to have the integrated controller 80 and the control circuit 39 of the ultrasonic welding device 30. In addition, third control device, which controls the positive-electrode tab bundle 15 to overlap with the end portion 17c of the positive electrode lead 17 by the second moving device, is constituted so as to have the integrated controller 80, the control circuit 49 of the stack-body moving device 40, and the control circuit 59 of the lead moving device 50. In the present description, a constitution which has the first control device and the third control device is referred to as “control device.”

Next, a description will be hereinafter given of actions of the ultrasonic welding system of the present embodiment.

Firstly, the device control unit 83 of the integrated controller 80 causes the holding mechanism 42 of the stack-body moving device 40 to actuate, thereby causing the holding mechanism 42 to hold the stack-body 10. As described above, in the present embodiment, the protective plate (not illustrated) is provided in the vicinity of the stacked body 10, and the holding mechanism 42 holds the stacked body 10 via the protective plate. Then, the device control unit 83 of the integrated controller 80 causes the movement mechanism 43 of the stack-body moving device 40 to actuate based on predetermined positional information on the ultrasonic wave applying zone H of the ultrasonic welding device 30. The actions cause the holding mechanism 42 which holds the stacked body 10 to move in the −X direction. And, a portion of the positive-electrode tab bundle 15 extending from the stacked body 10, which is held by the holding mechanism 42, is positioned at the center inside the ultrasonic wave applying zone H of the ultrasonic welding device 30, thereby completing positioning of the positive-electrode tab bundle 15.

The portion of the positive-electrode tab bundle 15 is an intermediate portion 15a of the positive-electrode tab bundle 15 in a direction in which the positive-electrode tab bundle 15 extends (the X direction in FIG. 2). The intermediate portion 15a is not restricted to being placed at an intermediate position of the positive-electrode tab bundle 15 (the center of the positive-electrode tab bundle 15 in the X direction) but may be placed at any position where a base portion of the positive-electrode tab bundle 15 will not interfere with an end portion of the positive electrode lead 17 on folding back the positive electrode lead 17 as described above and also welding can be done by the ultrasonic welding system.

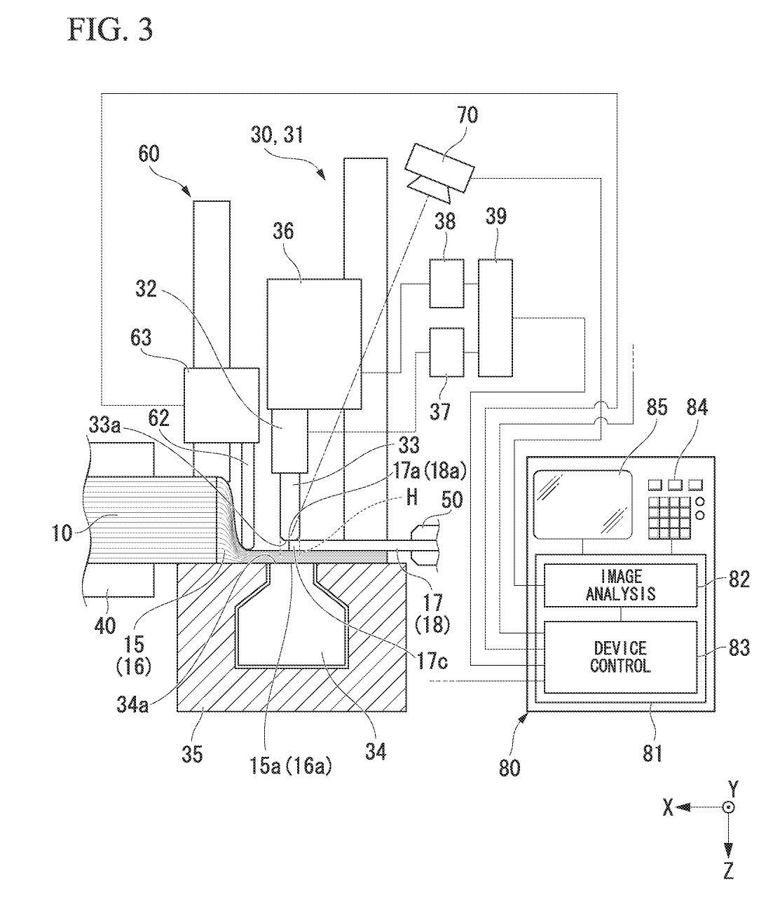

When the intermediate portion 15a of the positive-electrode tab bundle 15 is positioned at the center inside the ultrasonic wave applying zone H of the ultrasonic welding device 30, as shown in FIG. 3, the device control unit 83 of the integrated controller 80 causes the tab pressing device 60 to press an area between the intermediate portion 15a of the positive-electrode tab bundle 15 and the stacked body 10. That is, the pressing member 62 of the tab pressing device 60 is caused to move in the +Z direction, thereby pressing the pressing member 62 to the positive-electrode tab bundle 15.

Next, the device control unit 83 of the integrated controller 80 causes the holding mechanism 52 of the lead moving device 50 to actuate and causes the holding mechanism 52 to hold the positive electrode lead 17.

Then, the device control unit 83 of the integrated controller 80 causes the movement mechanism 53 of the lead moving device 50 to actuate in such a manner that the outer edge 17a on the side of the stacked body 10, which is at the end portion 17c of the positive electrode lead 17 held by the holding mechanism 52, overlaps with the intermediate portion 15a of the positive-electrode tab bundle 15. Thereby, the holding mechanism 52 which holds the positive electrode lead 17 moves in the +X direction, by which the outer edge 17a overlaps with the intermediate portion 15a. In this instance, when the image analysis unit 82 of the integrated controller 80 analyzes an image sent from the camera 70 to recognize the outer edge 17a of the positive electrode lead 17, the image analysis unit 82 successively notifies the device control unit 83 of a position of the outer edge 17a of the positive electrode lead 17. The device control unit 83 causes the movement mechanism 53 of the lead moving device 50 to actuate by referring to a difference between a position indicated by the predetermined positional information on the center inside the ultrasonic wave applying zone H and a position of the outer edge 17a of the positive electrode lead 17 so as to make this difference zero.

Actions of the lead moving device 50 enable the outer edge 17a of the positive electrode lead 17 to overlap accurately with the intermediate portion 15a of the positive-electrode tab bundle 15 which is positioned inside the ultrasonic wave applying zone H.

When the outer edge 17a of the positive electrode lead 17 overlaps with the intermediate portion 15a of the positive-electrode tab bundle 15 positioned inside the ultrasonic wave applying zone H, the device control unit 83 instructs the ultrasonic welding device 30 to start welding.

When the ultrasonic welding device 30 receives the instruction, the ultrasonic welding device 30 outputs ultrasonic waves from the horn 33, and also the compression mechanism 36 of the ultrasonic welding device 30 is driven to move the horn 33 in the +Z direction. In this process, the ultrasonic wave applying surface 33a of the horn 33 is in contact with a portion including the outer edge 17a of the positive electrode lead 17 inside the ultrasonic wave applying zone H, and a pressure is applied in such a manner that a contact pressure acting between the ultrasonic wave applying surface 33a and a portion including the outer edge 17a of the positive electrode lead 17 reaches a target contact pressure. As a result, the positive-electrode tab bundle 15 is connected to the positive electrode lead 17. As described in FIG. 4A and FIG. 4B below, the ultrasonic wave applying surface 33a is in contact with the portion including the outer edge 17a of the positive electrode lead so that the ultrasonic wave applying surface 33a covers the positive electrode lead 17 in the Y direction as well.

As a result, the end portion 17c of the positive electrode lead 17 including the outer edge 17a of the positive electrode lead 17 and the intermediate portion 15a of the positive-electrode tab bundle 15 are melted. Then, as shown in FIG. 4A and FIG. 4B, almost no clear boundary line is found between the outer edge 17a of the positive electrode lead 17 and the positive-electrode tab bundle 15 owing to a connected portion M which is a zone where the end portion 17c of the positive electrode lead 17 including the outer edge 17a is connected to the intermediate portion 15a of the positive-electrode tab bundle 15. Therefore, there is no chance that the outer edge of the lead is bended up to damage the base portion of the tab bundle, making it possible to avoid a contact failure between an electrode plate and an electrode terminal. Although in FIG. 1, the outer edge 17a of the positive electrode lead 17 is clearly depicted, this is to indicate the existence of the outer edge 17a of the positive electrode lead 17. In reality, as described previously, the outer edge 17a is melted to result in almost no clear boundary line between the outer edge 17a of the positive electrode lead 17 and the positive-electrode tab bundle 15.

As shown in FIG. 4B, here, attention is to be given to a positional relationship between the horn 33, the outer edge 17a and the intermediate portion 15a. That is, the center of the ultrasonic wave applying surface 33a of the horn 33 is positioned at a site which overlaps with the outer edge 17a, and a half area from the center of the ultrasonic wave applying surface 33a is positioned in the +X direction from the outer edge 17a of the positive electrode lead 17.

In the present embodiment, the center of the ultrasonic wave applying surface 33a is to overlap with the outer edge 17a (to be positioned at the same site in the X direction). However, with driving accuracy of the ultrasonic welding system taken into account, at least, a portion of the ultrasonic wave applying surface 33a may be positioned in the +X direction from the outer edge 17a of the positive electrode lead 17. More specifically, where an error of positioning accuracy in the X direction by the movement mechanism 53 which controls the positive electrode lead 17 to move in the X direction is defined as ±ΔX and a width of the ultrasonic wave applying surface 33a in the X direction is defined as X1, the X1 which meets a relationship of X1>(2×ΔX) may be given as a width of the ultrasonic wave applying surface 33a in the X direction.

Thereby, for example, even where the ultrasonic welding system is low in driving accuracy, a portion including the outer edge 17a of the positive electrode lead 17 can be reliably subjected to ultrasonic welding.

After termination of connecting the positive-electrode tab bundle 15 to the positive electrode lead 17 by the ultrasonic welding device 30, the device control unit 83 of the integrated controller 80 causes the tab pressing device 60 to release the positive-electrode tab bundle 15. That is, the pressing member 62 of the tab pressing device 60 is caused to move in the −Z direction, by which the pressing member 62 is detached from the positive-electrode tab bundle 15.

Then, the device control unit 83 of the integrated controller 80 causes the holding mechanism 52 of the lead moving device 50 to release the positive electrode lead 17. Thereby, the positive-electrode tab bundle 15 is connected to the positive electrode lead 17 by the ultrasonic welding system.

After the positive-electrode tab bundle 15 is completely connected to the positive electrode lead 17, the stacked body 10 is caused to move. Then, the negative-electrode tab bundle 16 is caused to be positioned inside the ultrasonic wave applying zone H, by which in the same procedures as those of the positive-electrode tab bundle 15, connecting of the negative-electrode tab bundle 16 to the negative electrode lead 18 is started.

As described above, in the present embodiment, since the portion including the outer edge 17a of the positive electrode lead 17 is connected to the positive-electrode tab bundle 15, the outer edge of the positive electrode lead 17 is not bended up to the positive-electrode tab bundle 15 as in the conventional technology. Further, the outer edge 17a of the positive electrode lead 17 is melted, by which almost no clear boundary line is found between the outer edge 17a of the positive electrode lead 17 and the tab bundle 15. This also the same to the case where the negative-electrode tab bundle 16 is connected to the lead 18.

As a result, in the present embodiment, even if the leads 17, 18 are folded back when the stacked body 10 in which the leads 17, 18 are connected respectively to the tab bundles 15, 16 is contained in the cell case 20, it is possible to avoid the connection failure between the electrode plate and the electrode terminal due to the damage at the base portion of the tab bundles 15, 16 by the outer edge of the leads 17, 18.

In the above-described embodiment, the integrated controller 80 causes the positive-electrode tab bundle 15 to be positioned inside the ultrasonic wave applying zone H based on the predetermined positional information on the ultrasonic wave applying zone H. It is, however, acceptable that a mark is placed to the intermediate portion 15a of the positive-electrode tab bundle 15, and the integrated controller 80 recognizes the mark by referring to an image sent from the camera 70, thereby causing the positive-electrode tab bundle 15 to be positioned inside the ultrasonic wave applying zone H based on a difference between a position of the mark and a position indicated by the predetermined positional information on the ultrasonic wave applying zone H.

Further, in the above-described embodiment, after the positive-electrode tab bundle 15 is connected to the positive electrode lead 17, the stacked body 10 is caused to move. Thereby, the negative-electrode tab bundle 16 is caused to be positioned inside the ultrasonic wave applying zone H, and the negative-electrode tab bundle 16 is connected to the negative electrode lead 18 at this position. However, it is also acceptable that the pressing device 60 and the ultrasonic welding device 30 are provided for each of the tab bundles 15, 16, and the stacked body 10 is temporarily arranged at a certain position (regarding the positive-electrode tab bundle 15, at a position where the outer edge 17a of the positive electrode lead 17 overlaps with the intermediate portion 15a and, regarding the negative-electrode tab bundle 16, at a position where the outer edge 18a of the negative electrode lead 18 overlaps with the intermediate portion 16a), at which the positive-electrode tab bundle 15 is connected to the positive electrode lead 17 and the negative-electrode tab bundle 16 is also connected to the negative electrode lead 18.

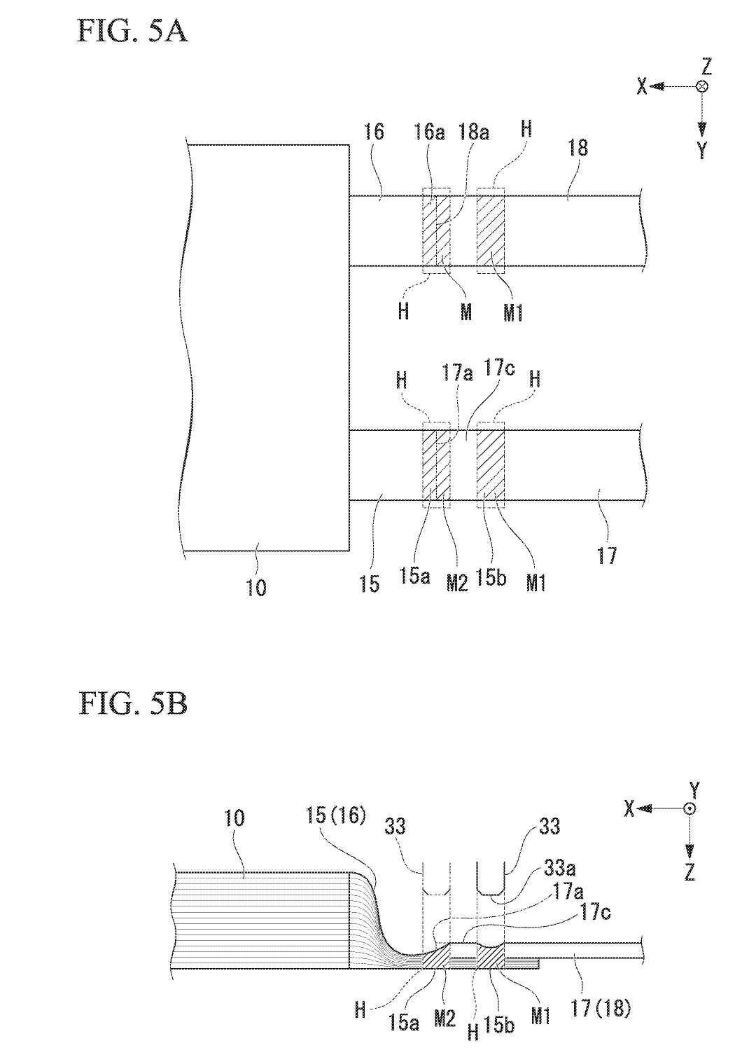

Next, a description will be given of a modified example where leads 17, 18 are connected respectively to the tab bundles 15, 16 of the present embodiment with reference to FIG. 2, FIG. 5A and FIG. 5B.

In the above-described embodiment, a portion of the positive electrode lead 17 connected to the positive-electrode tab bundle 15 is only one portion which includes the outer edge 17a of the positive electrode lead 17. However, in the present modified example, a portion which includes an outer edge 17a of a positive electrode lead 17 and also a portion spaced away at a certain interval from this portion in the −X direction, that is, two portions are to be connected. In the present modified example as well, a description will be given of a case where a positive-electrode tab bundle 15 is connected to the positive electrode lead 17. A brief description will be given of a negative-electrode tab bundle 16 connected to a negative electrode lead 18.

As shown in FIG. 2, FIG. 5A and FIG. 5B, a device control unit 83 of an integrated controller 80 causes a movement mechanism 43 of a stack-body moving device 40 to actuate in such a manner that a portion of the positive-electrode tab bundle 15 extending from a stacked body 10 held by a holding mechanism 42 of the stack-body moving device 40 is positioned inside an ultrasonic wave applying zone H of an ultrasonic welding device 30 based on predetermined positional information on the ultrasonic wave applying zone H of the ultrasonic welding device 30. In this instance, the portion of the positive-electrode tab bundle 15 is a leading-end portion 15b which is spaced away at a certain interval to the leading end of the positive-electrode tab bundle 15 (in −X direction) from an intermediate portion 15a of the positive-electrode tab bundle 15 in a direction in which the positive-electrode tab bundle 15 extends (in X direction), that is, a portion which is at first to be connected to the positive electrode lead 17. The certain interval is not in particular restricted and may be set, whenever necessary, depending on design conditions of a battery.

When the leading-end portion 15b of the positive-electrode tab bundle 15 is positioned inside the ultrasonic wave applying zone H, the integrated controller 80 causes a tab pressing device 60 to press the positive-electrode tab bundle 15. Then, the integrated controller 80 causes a movement mechanism 53 of a lead moving device 50 to actuate in such a manner that an end portion 17c of the positive electrode lead 17 overlaps with the intermediate portion 15a and the leading-end portion 15b of the positive-electrode tab bundle 15, with the positive electrode lead 17 held by the lead moving device 50. Here, the integrated controller 80 controls actions of a lead moving device 51 based on the positional information on the ultrasonic wave applying zone H in such a manner that the end portion 17c of the positive electrode lead 17 overlaps with the intermediate portion 15a and the leading-end portion 15b of the positive-electrode tab bundle 15. In this instance, it is acceptable that the integrated controller 80 recognizes the outer edge 17a of the positive electrode lead 17 by referring to an image sent from a camera 70 and controls actions of the lead moving device 51 based on a position of the outer edge 17a of the positive electrode lead 17 and the predetermined positional information on the ultrasonic wave applying zone H in such a manner that the end portion 17c of the positive electrode lead 17 overlaps with the intermediate portion 15a and the leading-end portion 15b of the positive-electrode tab bundle 15.

Due to the above-described actions, the outer edge 17a of the positive electrode lead 17 overlaps with the intermediate portion 15a of the positive-electrode tab bundle 15. And, as to the positive electrode lead 17, the portion spaced away at a certain interval from the outer edge 17a of the positive electrode lead 17 in the −X direction overlaps with the leading-end portion 15b of the positive-electrode tab bundle 15. In the following description, the portion of the positive electrode lead 17 which overlaps with the leading-end portion 15b of the positive-electrode tab bundle 15 inside the ultrasonic wave applying zone H is defined as a first welded spot M1.

When the leading-end portion 15b of the positive-electrode tab bundle 15 is positioned inside the ultrasonic wave applying zone H, and the outer edge 17a of the positive electrode lead 17 overlaps with the intermediate portion 15a of the positive-electrode tab bundle 15 and the first welded spot M1 of the positive electrode lead 17 overlaps with the leading-end portion 15b of the positive-electrode tab bundle 15, the device control unit 83 of the integrated controller 80 instructs the ultrasonic welding device 30 to start welding. In addition, the first welded spot M1 of the positive electrode lead 17 is connected to the leading-end portion 15b of the positive-electrode tab bundle 15 by the ultrasonic welding device 30.

When the first welded spot M1 of the positive electrode lead 17 is connected to the leading-end portion 15b of the positive-electrode tab bundle 15, the device control unit 83 of the integrated controller 80 causes the tab pressing device 60 to release the positive-electrode tab bundle 15. Thereafter, the device control unit 83 controls the stack-body moving device 40 and the lead moving device 50 so that the intermediate portion 15a of the positive-electrode tab bundle 15 is caused to be positioned inside the ultrasonic wave applying zone H and the portion including the outer edge 17a of the positive electrode lead 17 is also caused to be positioned inside the ultrasonic wave applying zone H.

In this instance, when an image analysis unit 82 of the integrated controller 80 processes an image sent from the camera 70 to recognize the outer edge 17a of the positive electrode lead 17, the image analysis unit 82 successively notifies the device control unit 83 of a position of the outer edge 17a of the positive electrode lead 17. The device control unit 83 determines a necessary moving distance from a difference between a position indicated by the predetermined positional information on the center inside the ultrasonic wave applying zone H and the position of the outer edge 17a of the positive electrode lead 17. Then, the device control unit 83 successively transmits the moving distance to the stack-body moving device 40 and the lead moving device 50. The stack-body moving device 40 causes the stacked body 10 to move according to the moving distance, thereby causing the intermediate portion 15a of the positive-electrode tab bundle 15 to be positioned at the center inside the ultrasonic wave applying zone H. Further, the lead moving device 50 causes the positive electrode lead 17 to move according to the moving distance, thereby causing a second welded spot M2 including the outer edge 17a of the positive electrode lead 17 to be positioned inside the ultrasonic wave applying zone H. That is, in this instance, the stacked body 10 and the positive electrode lead 17 move in the −X direction by an equal distance. Then, the intermediate portion 15a of the positive-electrode tab bundle 15 extending from the stacked body 10 and the second welded spot M2 including the outer edge 17a of the positive electrode lead 17 are both to be positioned inside the ultrasonic wave applying zone H.

When the intermediate portion 15a of the positive-electrode tab bundle 15 extending from the stacked body 10 and the second welded spot M2 including the outer edge 17a of the positive electrode lead 17 are both positioned inside the ultrasonic wave applying zone H, the integrated controller 80 causes the tab pressing device 60 to press the positive-electrode tab bundle 15 and, thereafter, instructs the ultrasonic welding device 30 to start welding. Then, the second welded spot M2 including the outer edge 17a of the positive electrode lead 17 is connected to the intermediate portion 15a of the positive-electrode tab bundle 15 by the ultrasonic welding device 30. A positional relationship between an ultrasonic wave applying surface 33a of a horn 33 and the outer edge 17a of the positive electrode lead 17 on welding the second welded spot 1V12 is the same as that of the above-described embodiment.

After termination of connecting the positive-electrode tab bundle 15 to the positive electrode lead 17, the integrated controller 80 thereafter causes each device to carry out the same actions which have been carried out to the positive-electrode tab bundle 15 by each device, thereby connecting the negative-electrode tab bundle 16 to the negative electrode lead 18.

In the present modified example, a width of the first welded spot M1 in the X direction, a width of the second welded spot M2 and a width between the first welded spot M1 and the second welded spot M2 are all approximately 2 mm to 3 mm.

As described above, in the present modified example as well, as with the previously described embodiment, the outer edges 17a, 18a of the leads 17, 18 are not bended up respectively against the tab bundles 15, 16, and almost no clear boundary lines are found between the outer edges 17a, 18a of the leads 17, 18 and the tab bundles 15, 16. It is, thereby, possible to avoid a connection failure between an electrode plate and an electrode terminal.

Further, in the present modified example, the tab bundles 15, 16 are connected respectively to the leads 17, 18 at two sites, thus making it possible to decrease a connecting strength at individual sites, as compared with the previously described embodiment in which they are connected only at one site. Therefore, the ultrasonic wave applying surface 33a of the horn 33 can be decreased in area to suppress a rated output of ultrasonic waves from the horn 33. As a result, it is possible to downsize the ultrasonic welding device 30 and reduce initial costs of the ultrasonic welding device 30.

Still further, in the present modified example, the first welded spot M1 of the positive electrode lead 17 is connected to the leading-end portion 15b of the positive-electrode tab bundle 15 and, thereafter, the second welded spot M2 including the outer edge 17a of the positive electrode lead 17 is connected to the intermediate portion 15a of the positive-electrode tab bundle 15. Therefore, on connecting the outer edge 17a of the positive electrode lead 17, a relative position between an end portion including the outer edge 17a of the positive electrode lead 17 and the positive-electrode tab bundle 15 is reliably fixed. It is, thus, possible to connect relatively easily the second welded spot M2 including the outer edge 17a of the positive electrode lead 17 to the intermediate portion 15a of the positive-electrode tab bundle 15.

In the present modified example, the first welded spot M1 is equal in width in the X direction to the second welded spot M2. However, the width may be made different. For example, the width of the second welded spot M2 is made greater than the width of the first welded spot M1, by which the second welded spot M2 can be reliably subjected to ultrasonic welding together with the outer edge 17a of the positive electrode lead 17, with a connecting strength suppressed at individual sites. Further, the rated output of ultrasonic waves from the horn 33 can be suppressed at the first welded spot M1.

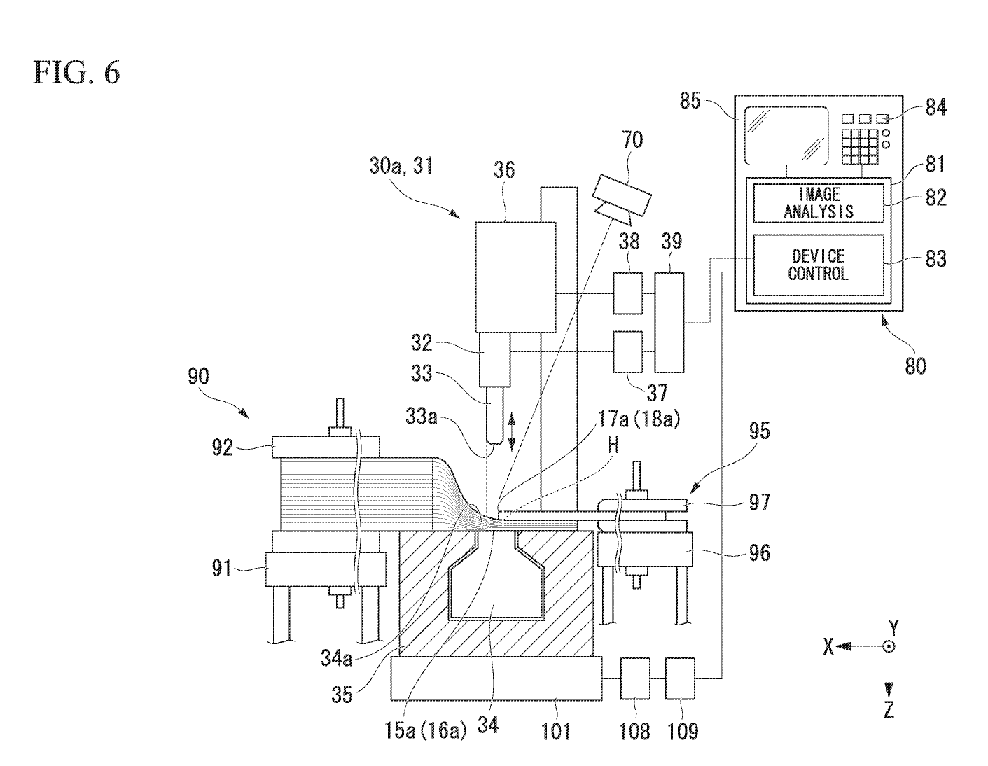

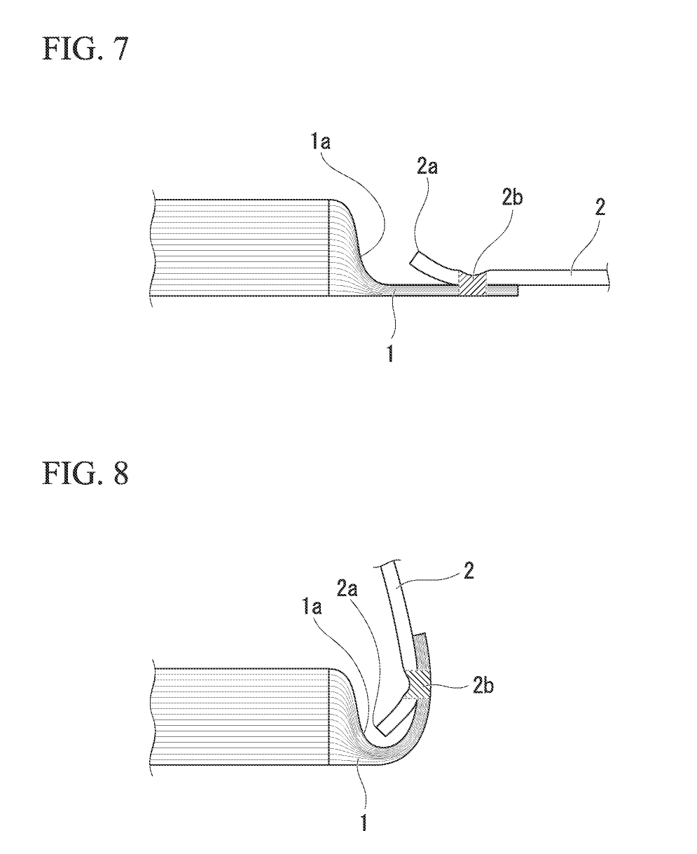

Next, a description will be given of a modified example of the ultrasonic welding system of the present embodiment with reference to FIG. 6.

The ultrasonic welding system of the present modified example includes an ultrasonic welding device 30a, a stack-body fixing jig 90 which fixes a stacked body 10 to a certain position, a lead fixing jig 95 which fixes leads 17, 18 to certain positions as well as a camera 70 and an integrated controller 80 similar to those of the previously described embodiment.

The ultrasonic welding device 30a of the present modified example includes an ultrasonic welder 31 and a control circuit 39 thereof which are similar to those of the previously described embodiment as well as a welder movement mechanism 101 which controls the ultrasonic welder 31 to move in the X direction and the Y direction, a driving circuit 108 thereof, and a control circuit 109 which controls the driving circuit 108.

The stack-body fixing jig 90 includes a stack-body placing table 91 which is fixed in the vicinity of a table 35 of the ultrasonic welder 31 and a stack-body holding jig 92 which holds the stacked body 10 and fixes the stacked body 10 onto the stack-body placing table 91. Further, the lead fixing jig 95 includes a lead placing table 96 which is fixed in the vicinity of the table 35 of the ultrasonic welder 31 and a lead holding jig 97 which holds the leads 17, 18 and fixes the leads 17, 18 onto the lead placing table 96.

In the ultrasonic welding system of the present modified example, a first moving device which changes a relative position between the leads 17, 18 and the horn 33 of the ultrasonic welder 31 is constituted so as to have the welder movement mechanism 101 and the driving circuit 108 thereof. That is, in the present invention, the first moving device may be one which controls the leads 17, 18 to move as described in the previously described embodiment or may be one which controls the ultrasonic welder 31 to move as described in the present modified example. Further, in the present modified example, the first control device, which controls the first moving device to change the relative position between the leads 17, 18 and the horn 33 based on an image sent from an imaging device (camera 70), is constituted so as to have the control circuit 109 for the welder movement mechanism 101 and the integrated controller 80. Still further, the second control device, which controls the ultrasonic welder 31 to connect the positive-electrode tab bundle 15 and the negative-electrode tab bundle 16 to the leads 17, 18, is constituted so as to have the integrated controller 80 and the control circuit 39 for the ultrasonic welder 31, as with the previously described embodiment.

Next, a description will be given of actions of the ultrasonic welding system described above and those of an operator. Here, there will be described a case where the positive-electrode tab bundle 15 is connected to the positive electrode lead 17. And, a description will be omitted for a case where the negative-electrode tab bundle 16 is connected to the negative electrode lead 18 because this is similar to the case where the positive-electrode tab bundle 15 is connected to the positive electrode lead 17.

First, an operator will fix the stacked body 10 by using the stack-body fixing jig 90 in such a manner that the intermediate portion 15a of the positive-electrode tab bundle 15 is positioned on the table 35 of the ultrasonic welder 31 and also within a photographing range by the camera 70. Then, the operator will fix the positive electrode lead 17 by using the lead fixing jig 95 in such a manner that the outer edge 17a of the positive electrode lead 17 overlaps with the intermediate portion 15a of the positive-electrode tab bundle 15 which is positioned on the table 35 of the ultrasonic welder 31.

After fixing the stacked body 10 by the stack-body fixing jig 90 and fixing the positive electrode lead 17 by the lead fixing jig 95, the operator will instruct the integrated controller 80 to start welding.

When the integrated controller 80 is so instructed, the image analysis unit 82 of the integrated controller 80 recognizes the outer edge 17a of the positive electrode lead 17 which overlaps with the intermediate portion 15a of the positive-electrode tab bundle 15 from an image sent from the camera 70. Then, it notifies the device control unit 83 of a position of the outer edge 17a of the positive electrode lead 17. The device control unit 83 causes the welder movement mechanism 101 to actuate according to a difference in the XY directions between the position of the outer edge 17a of the positive electrode lead 17 and a position of the ultrasonic wave applying surface 33a of the horn 33.

Due to actions of the welder movement mechanism 101, the ultrasonic wave applying surface 33a of the horn 33 overlaps with the intermediate portion 15a of the positive-electrode tab bundle 15 and the outer edge 17a of the positive electrode lead 17 in the XY directions.

When the ultrasonic wave applying surface 33a of the horn 33 overlaps with the intermediate portion 15a of the positive-electrode tab bundle 15 and the outer edge 17a of the positive electrode lead 17, the device control unit 83 of the integrated controller 80 instructs the ultrasonic welding device 30 to start welding.

When the ultrasonic welding device 30a is so instructed, ultrasonic waves are output from the horn 33 of the ultrasonic welding device 30a, and the compression mechanism 36 of the ultrasonic welding device 30a is also actuated, thereby causing the horn 33 to move in the +Z direction. Then, the ultrasonic wave applying surface 33a of the horn 33 is brought into contact with a portion including the outer edge 17a of the positive electrode lead 17. Further, a pressure is applied so as to bring a contact pressure acting between them to a target contact pressure, by which the positive electrode lead 17 is connected to the positive-electrode tab bundle 15.

As a result, the end portion of the positive electrode lead 17 including the outer edge 17a and the intermediate portion 15a of the positive-electrode tab bundle 15 are melted. Thereby, as with the previously described embodiment, the end portion of the positive electrode lead 17 including the outer edge 17a is connected to the intermediate portion 15a of the positive-electrode tab bundle 15. And, almost no clear boundary line is found between the outer edge 17a of the positive electrode lead 17 and the positive-electrode tab bundle 15.

As described above, in the present modified example which is much simpler in system constitution than the previously described embodiment, the end portion of the positive electrode lead 17 including the outer edge 17a is melted and connected to the positive-electrode tab bundle 15. Therefore, as with the previously described embodiment, it is possible to avoid a connection failure between an electrode plate and an electrode terminal.

In the embodiment and the present modified example described above, a mechanism of each device is controlled by the control circuit provided for each device and the integrated controller 80. However, functions of the control circuit provided for each device may be assembled into the integrated controller 80.

### INDUSTRIAL APPLICABILITY

When a lead is folded back for containing the lead in a battery case, an outer edge of the lead will not damage a base portion of a tab bundle. It is, thus, possible to avoid a connection failure between an electrode plate and an electrode terminal.
10: Stacked body
11: Positive electrode plate
12: Negative electrode plate
13: Separator
15: Tab bundle (positive-electrode tab bundle)
16: Tab bundle (negative-electrode tab bundle)
17: Lead (positive electrode lead)
18: Lead (negative electrode lead)
17a, 18a: Outer edge of lead
20: Cell case
21: Positive electrode terminal
22: Negative electrode terminal
30, 30a: Ultrasonic welding device
31: Ultrasonic welder
40: Stack-body moving device
41: Stack-body moving device
50: Lead moving device
51: Lead moving device
60: Tab pressing device
70: Camera
80: Comprehensive controller
81: Control part
82: Image analysis part
83: Device control part
101: Welder movement mechanism

1. A battery comprising:
an electrode stacked body, in which a plurality of electrode plates are stacked; and
a lead having the first end which is connected to a tab bundle formed by putting together tabs extending individually from the plurality of electrode plates, wherein
the first end of the lead is connected to the tab bundle by ultrasonic welding so as to include at least an outer edge of the lead.

2. The battery according to claim 1, wherein
the outer end of the lead is connected to an electrode terminal, and
a portion of the lead, which is between the outer edge of the lead and the electrode terminal and is spaced away at a certain interval from the outer edge of the lead, is connected to the tab bundle additionally by ultrasonic welding.

3. An ultrasonic welding system which connects a lead to a tab bundle in a battery having an electrode stacked body, in which a plurality of electrode plates are stacked, and having the tab bundle formed by putting together tabs extending individually from the plurality of electrode plates, the ultrasonic welding system comprising:
an ultrasonic welder having a horn which applies ultrasonic waves to a welded spot between the tab bundle and the lead to weld the welded spot;
a moving device which changes a relative position between the tab bundle, the lead and the horn;
an imaging device which takes photographs of a zone to which the horn applies the ultrasonic waves;
a control device which controls at least two of the tab bundle, the lead and the horn to move relatively by the moving device in such a manner that the tab bundle, an outer edge of the lead and an ultrasonic wave applying surface of the horn are arrayed in a direction in which the horn moves in the zone where the imaging device takes photographs; and
a second control device which controls the ultrasonic wave applying surface of the horn to move toward a zone including the outer edge of the lead, thereby connecting the zone including at least the outer edge of the lead to the tab bundle by the ultrasonic welder.
